(19) United States
(12) Patent Application Publication
(10) Pub. No.: US 2007/0049120 A1
(43) Pub. Date: Mar. 1, 2007

(54) Active cable assembly for use in universal serial bus

(75) Inventor: Steven M. Hemmah, Salem, NH (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/211,203

(22) Filed: Aug. 25, 2005

(51) Int. Cl. H01R 13/66

(52) U.S. Cl. 439/620.01

(57) ABSTRACT

An active cable assembly for use in Universal Serial Bus (USB) that includes at least one USB node, the cable assembly managing power delivered through the cable assembly.

### FIELD OF THE INVENTION

The present invention is generally related to the field of connectors and more particularly to USB connectors and cable assemblies.

### BACKGROUND OF THE INVENTION

Connectors and cable assemblies are adapted to provide physical and electrical interconnection between devices. USB-type connectors are defined by USB standards, and include many types including Series “A” and B”. Series “B” plugs are always oriented upstream towards a host system, and Series “A” receptacles are always oriented downstream from the USB host or hub. Conversely series “B” plugs and receptacles are always oriented the other way.

Conventionally, active power management of a USB connectors and cables is provided by a power management IC solution on a printed circuit board (PCB). Disadvantageously, this solution requires space on the PCB and increases the PCB size, which already is significant to provide other-valued features.

### SUMMARY OF INVENTION

The present invention achieves technical advantages as a active cable assembly for use in Universal Serial Bus (USB) that includes at least one USB node.

### BRIEF DESCRIPTION OF THE DRAWINGS

FIG. 1 depicts a cable assembly including a connector and a USB Series “B” connector according to one preferred embodiment of the invention;

FIG. 2 depicts a Series “A” connector according to a preferred embodiment of the invention; and

FIG. 3 depicts a Series “B” USB connector according to another preferred embodiment of the invention.

### DETAILED DESCRIPTION OF THE PRESENT INVENTION

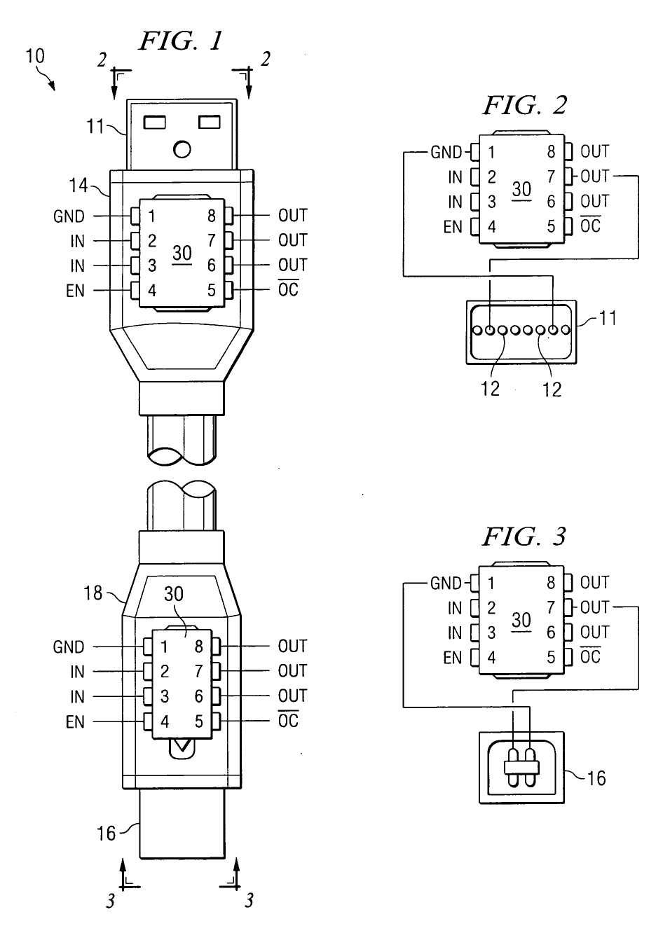

Referring now to FIG. 1, there is shown an active cable assembly 10 including a USB Series “A” connector 11 having at least one first electrical contact 12 mounted in a connector housing 14 and arranged for detachable connection with corresponding electrical contacts of a receptacle. Connector 11 includes at least one second electrical contact 20 mounted in the connector housing 14 and arranged for connection with corresponding electrical contacts of a receptacle, such as of USB network equipment, (not shown). Advantageously, cable assembly 10 further includes active power control circuitry 30 located within the connector housing 14 and coupled to at least some of the first electrical contacts 12 and second electrical contacts 20. The active power control circuitry 30 is configured and operative for controlling the supply of electrical power delivered over the USB network cabling to at least one node of the USB network.

The active USB cable assembly 10 is configured to manage at least one USB node for at least one of these functions: voltage, current, power, over-current protection, low-power bus-powered functions, high-power bus-powered functions, self-powered functions, voltage drop budget, power control during suspend/resume, dynamic attach and detach, and inrush current limiting.

The active USB cable assembly 10 is configured to be connected to Series “A and Series “B” receptacles as defined by USB Standards. FIG. 1 depicts the invention including a single pin-type series “A” connector at one end and a Series “B” connector 16 at the other end. FIG. 2 depicts the series “A” connector including the active circuitry 30. FIG. 3 depicts the Series “B” connector having active circuitry 30.

The active USB cable assembly 10 may be applied to at least one USB node in USB Hubs as defined by USB Standards as additional attachment points within the USB network. The active USB cable assembly 10 may be applied to at least one USB node in USB functions as defined by USB Standards as functions, which provide capabilities to the system.

The active USB cable assembly 10 advantageously manages the power distribution to at least one USB node over the USB network that deals with the issues of how USB devices consume power provided by the host over the USB. The active USB cable assembly 10 also advantageously manages the power management to at least one USB node that deals with how the USB network software and devices fit into the host-based power management system.

The active USB cable assembly 10 may be applied USB devices that rely totally on power from the cable that are called bus-powered devices as defined by USB Standards. The active USB cable assembly may also be applied USB devices—that have an alternate source of power that are called self-powered devices as defined by USB Standards.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A USB cable assembly, comprising:
a cable having electrical conductors;
a housing coupled to the cable;
first and second electrical contacts configured to receive electrical signals from a USB compliant device; and
an active power management circuit disposed in the housing and coupled to the first and second electrical contacts, the circuit being configured to manage power delivered through the USB cable assembly.

2. The USB cable assembly as specified in claim 1 wherein the active power management circuit comprise an integrated circuit (IC).

3. The USB cable assembly as specified in claim 2 wherein the USB cable assembly or plug is a Series “A” connector.

4. The USB cable assembly as specified in claim 2 wherein the USB cable assembly or plug is a Series “B” connector.
